(19) United States
(12) Patent Application Publication
(10) Pub. No.: US 2016/0180455 A1
(43) Pub. Date: Jun. 23, 2016

(54) GENERATING DEVICE, GENERATING METHOD, AND NON-TRANSITORY COMPUTER READABLE STORAGE MEDIUM

(71) Applicant: YAHOO JAPAN CORPORATION, Tokyo (JP)

(72) Inventor: Toru TAKATA, Tokyo (JP)

(73) Assignee: YAHOO JAPAN CORPORATION, Tokyo (JP)

(21) Appl. No.: 14/962,413

(22) Filed: Dec. 8, 2015

(30) Foreign Application Priority Data
Dec. 19, 2014 (JP) 2014-258115

(51) Int. Cl. G06Q 40/02; G06Q 10/06

(52) U.S. Cl. CPC G06Q 40/025; G06Q 10/067

(57) ABSTRACT

A generating device according to the present application includes an acquisition unit, and a generation unit. The acquisition unit acquires information concerning a company from information transmitted on a communication network. The generation unit generates a model for predicting an index value indicating credit to a first company based on information concerning the first company acquired by the acquisition unit, based on a correlation between information concerning a second company acquired by the acquisition unit and an index value indicating credit to the second company given by a third party.

### CROSS-REFERENCE TO RELATED APPLICATION(S)

The present application claims priority to and incorporates by reference the entire contents of Japanese Patent Application No. 2014-258115 filed in Japan on Dec. 19, 2014.

### BACKGROUND OF THE INVENTION

1. Field of the Invention

The present invention relates to a generating device, a generating method, and a non-transitory computer readable storage medium having stored therein a generating program.

2. Description of the Related Art

Generally, a financial institution such as a bank refers to company data provided by a specialist data providing company specializing in collection and analysis of enterprise (company) information, when determining a ceiling on financing. This company data is generated based on settlement of accounts of a company (such as financial statements and profit-and-loss statement), for example. Accordingly, a financial institution utilizes company data provided by a specialist company to calculate credit information for determining whether or not a financing amount set for each enterprise is appropriate.

With recent rapid spread of the Internet, there has been developed and become known a technology which increases objectivity of company data by using information about an enterprise shared by information users over the Internet in a manner of total and integrated management of the shared information, as well as conventional information based on settlement of company accounts or the like.

However, the accuracy of credit to a company calculated by the method of the related art described above is not necessarily high. More specifically, the related art described above only allows sharing of enterprise financial information presented to the public, enterprise trading performance available by information users, and information about news in the industry or the like. Even when these types of information are unified, the credit to the company is difficult to evaluate based on the information.

Moreover, according to the related art described above, sharing of accurate information is difficult for enterprises for which information users are unable to easily acquire information, such as privately held enterprises, small or middle-scale enterprises, and start-up enterprises. Accordingly, credit information for determining financing conditions for such privately held enterprises and start-up enterprises is difficult to acquire by using the method of the related art described above.

### SUMMARY OF THE INVENTION

It is an object of the present invention to at least partially solve the problems in the conventional technology.

A generating device to the present application includes an acquisition unit that acquires information concerning a company from information transmitted on a communication network, and a generation unit that generates a model for predicting an index value indicating credit to a first company based on information concerning the first company acquired by the acquisition unit, based on a correlation between information concerning a second company acquired by the acquisition unit and an index value indicating credit to the second company given by a third party.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a view illustrating an example of a generating process according to an embodiment;

FIG. 2 is a view illustrating an example of a process executed by a generating system according to the embodiment;

FIG. 3 is a view illustrating a configuration example of a generating device according to the embodiment;

FIG. 4 is a view illustrating an example of a company data storage unit according to the embodiment;

FIG. 5 is a view illustrating an example of a search information table according to the embodiment;

FIG. 6 is a view illustrating an example of a site information table according to the embodiment;

FIG. 7 is a view illustrating an example of a product information table according to the embodiment;

FIG. 8 is a view illustrating an example of a social information table according to the embodiment;

FIG. 9 is a view illustrating an example of a customer information table according to the embodiment;

FIG. 10 is a view illustrating an example of a model storage unit according to the embodiment;

FIG. 11 is a flowchart illustrating a generating process procedure executed by the generating device according to the embodiment;

FIG. 12 is a flowchart illustrating a calculating process procedure executed by the generating device according to the embodiment; and

FIG. 13 is a hardware configuration diagram illustrating an example of a computer realizing functions of the generating device.

### DETAILED DESCRIPTION OF THE PREFERRED EMBODIMENT

A mode for realizing a generating device, a generating method, and a non-transitory computer readable storage medium having stored therein a generating program according to the present application (hereinafter referred to as “embodiment”) is hereinafter described in detail with reference to the drawings. The generating device, the generating method, and the non-transitory computer readable storage medium having stored therein the generating program according to the present application are not limited to those described in the embodiment. In respective examples specifically described in the embodiment, similar parts have been given similar reference numbers, and the same explanation is not repeated.

### 1-1. Example of Generating Process

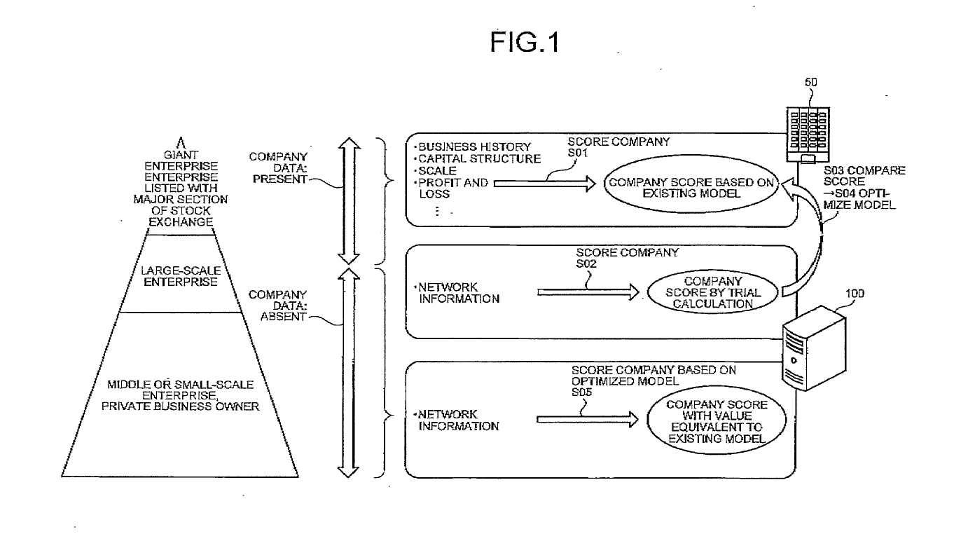

An example of a generating process according to the embodiment is hereinafter described with reference to FIG. 1. FIG. 1 is a view illustrating an example of the generating process according to the embodiment. The generating process illustrated in FIG. 1 is executed by a generating device 100 according to the embodiment to generate a calculation expression (model) for outputting an index value (score) which indicates credit to a company.

The generating device 100 illustrated in FIG. 1 is a server device which acquires information about a company via a not-shown communication network (such as the Internet), and generates a model for outputting a score indicating credit to the company (hereinafter abbreviated as “score”) based on the acquired information. More specifically, the generating device 100 acquires information concerning the company and produced based on user behaviors performed on the Internet (such as product evaluations transmitted from users to evaluate a product supplied by a company, reviews, and search information provided in a search site). Then, the generating device 100 analyzes a correlation between the acquired information and a score calculated by a specialist company data provider 50, which specializes in evaluation of credit to a company, to generate a model capable of outputting a score of the company based on network information.

The company data provider 50 illustrated in FIG. 1 is an enterprise which specializes in collection of financial or other information concerning a company, and calculation of credit to the company based on the collected information. For example, the company data provider 50 sells company credit information, such as a calculated score, to a financial institution or the like. The company data provider 50 has an original model for calculating a score of a company based on financial information about the company, and further on information about personal evaluations (such as personality and leadership of a manager) as necessary. For example, the company data provider 50 sets respective items such as stability, growth potential, manager ability, and openness to the public concerning a company, as items for evaluating the company. The company data provider 50 calculates scores corresponding to the respective items to calculate an overall score indicating credit to the company.

As illustrated in FIG. 1, a company is classified into a category such as a giant enterprise, an enterprise listed with a major section of a stock exchange, a large-scale enterprise, a middle or small-scale enterprise, and a private business owner in accordance with the scale and stock listing state of the company. Illustrated in the left part of FIG. 1 is a concept of categories such as giant enterprises, large-scale enterprises, and small or middle-scale enterprises to any one of which the company is to belong. In these categories, the giant enterprises and a part of the large-scale enterprises are classified into a group indicating “company data: present”. The company data in this context is financial information used for evaluating credit to a company, and information containing capital information and the like. The company data includes not only information presented to the public, but also information acquired based on individual investigations carried out by investigators belonging to the company data provider 50, for example. Accordingly, a company classified into the group “company data: present” is given a score indicating credit based on analysis of company data by the company data provider 50.

On the other hand, as for a company classified into a group “company data: absent”, company data is insufficient to be analyzed by the company data provider 50, wherefore a score indicating credit is not given to this company. This situation occurs when publication of financial information of the company is insufficient due to the unlisted state of the company in the stock exchange, or when the investigators of the company data provider 50 are practically difficult to investigate all of a large number of small and middle-scale companies, for example. Accordingly, the company data provider 50 is capable of calculating scores of only a part of relatively large-scale companies. In this case, many companies are difficult to receive proof for credit. As a result, these companies suffer from disadvantages such as refusal of financing by a financial institution, and inaccurate calculation of a financing amount.

In consideration of these circumstances, the generating device 100 executes processes described below to output a score indicating credit to a company in a manner other than acquisition of financial information presented to the public, and collection of personal information with assistance of investigators.

Initially, the generating device 100 acquires information about a model used by the company data provider 50 for calculating a company score in accordance with company data. In this case, the company data provider 50 scores a company based on business history, capital structure, scale, profit and loss, and other information about the company acquired as company data (step S01). In other words, the company data provider 50 gives a score to a company corresponding to a determination target based on an existing model possessed by the company data provider 50. The generating device 100 acquires company data provided (sold) by the company data provider 50 and containing a calculated score. In this case, the company data provider 50 also provides evaluation contents for respective items referred to when an overall score is given, and information about scores for the respective items.

According to this process, a company to which a score has been already given by the company data provider 50 is scored by the generating device 100 based on network information (step S02). For example, by the function of by the generating device 100, the degree of owned capital, collateral margin and the like used for evaluating “stability” by the company data provider 50 are associated with data available on the network to generate a model for outputting a score corresponding to “stability”, as will be detailed below. According to a specific example, the generating device 100 generates a model capable of outputting a score corresponding to the item of “stability” calculated by the company data provider 50 by using the number of searches of the name of the corresponding company in a search site, overall evaluations of product reviews of products sold by the corresponding company, and others. The generating device 100 executes these processes for each of items such as “growth potential”, “manager ability”, and “openness to the public”. The generating device 100 acquires a score of a company obtained by a trial calculation for the company using the model generated by these processes.

The generating device 100 compares the score obtained by the trial calculation using the generated model with the score calculated by the company data provider 50 (step S03). Based on this comparison, the generating device 100 derives network information appropriate for association with the score of the item “stability” calculated by the company data provider 50, and solutions to quantification and the like of the network information. In other words, the generating device 100 allows learning by the model generated by the generating device 100, while setting the model possessed by the company data provider 50 to a correct answer model. The generating device 100 optimizes the model by repeatedly using the model for multiple sets of company data (step S04).

By the use of the optimized model, the generating device 100 is capable of calculating a score of a small or middle-scale enterprise to which the company data provider 50 does not give a score. More specifically, the generating device 100 acquires network information concerning a small or middle-scale enterprise, and inputs the acquired information to a generated model. Then, the generating device 100 scores this company by using the optimized model (step S05). In this case, the generating device 100 gives a company, such as a small or middle-scale enterprise, a company score having a value equivalent to a value of a score which may be calculated based on an existing model possessed by a specialist such as the company data provider 50.

As described above, the generating device 100 according to this embodiment acquires information available on the communication network and concerning companies. Then, the generating device 100 generates a model for predicting a score indicating credit to a company not scored by the company data provider 50, based on a correlation between the acquired information concerning the company scored by the company data provider 50 and a score given by the company data provider 50.

Accordingly, the generating device 100 according to the embodiment is capable of measuring credit to a company, and generating a model for scoring in a manner other than the use of financial information or the like about an enterprise generally adopted for determining financing conditions. In other words, the generating device 100 is capable of calculating a company score without the necessity of referring to a score given by the company data provider 50 as a specialist institution which evaluates credit to a company based on financial information or the like. In this case, the generating device 100 is capable of calculating a score of a small or middle-scale enterprise, a private business owner, a start-up enterprise or the like not scored by the company data provider 50, and capable of providing the calculated score as credit information. As a result, the small or middle-scale enterprise or the like is allowed to receive appropriate financing from a financial institution or the like. Moreover, the generating device 100 is capable of acquiring information constituted by a considerable number of samples indicating user behaviors performed on the Internet. In this case, the generating device 100 is capable of optimizing a model by leaning a number of samples while setting a score provided by the company data provider 50 as correct answer data. Accordingly, the generating device 100 is capable of generating a model for calculating a highly accurate score, thereby achieving highly accurate calculation of credit to a company. The score calculated by the generating device 100 is utilized not only for the purpose of financial support, but also for various types of sales activities of a company (such as credit to an advertiser distributing advertisements, and credit to a member store of a shopping site).

### 1-2. Generating System

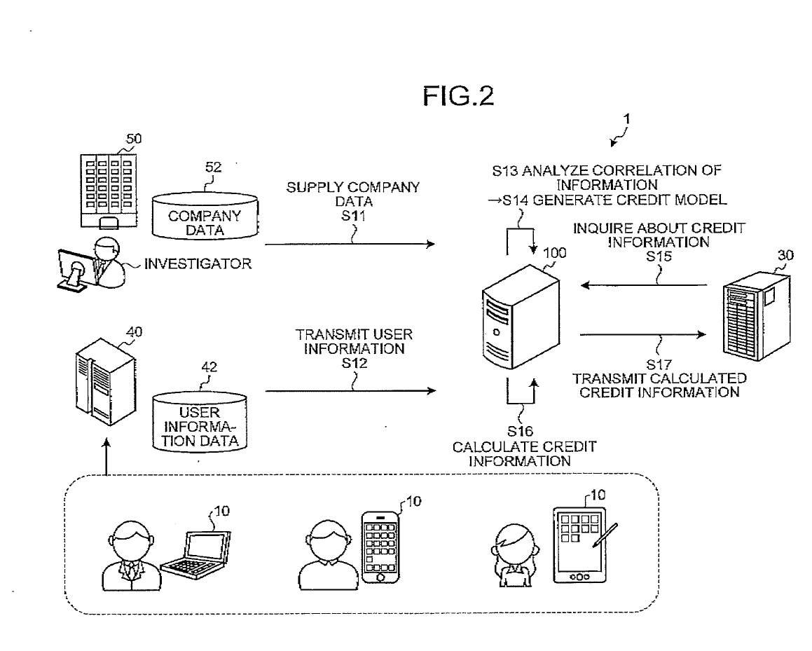

A process executed by a generating system according to the embodiment is hereinafter described with reference to FIG. 2. FIG. 2 is a view illustrating an example of the process executed by a generating system 1 according to the embodiment. The generating system 1 illustrated in FIG. 2 presented by way of example is hereinafter described to detail the flow of the generating process executed by the generating device 100 illustrated in FIG. 1.

As illustrated in FIG. 2, the generating system 1 includes user terminals 10, a financial institution server 30, a web server 40, and the generating device 100. The generating device 100 communicatively connects with the user terminals 10, the financial institution server 30, and the web server 40 via a not-shown communication network (such as the Internet). Each of the numbers of the user terminals 10, the financial institution server 30, and the web server 40 included in the generating system 1 is not limited to the number illustrated in the example of FIG. 2. For example, the plurality of financial institution servers 30, and the plurality of web servers 40 may be included in the generating system 1.

Each of the user terminals 10 is an information processing device used by an ordinary user. More specifically, each of the user terminals 10 is used by a user for viewing a web page, posting evaluations of product information in a website, or for other purposes. Each of the user terminals 10 is constituted by a mobile terminal such as a smartphone, a tablet-type terminal, and a PDA (personal digital assistant), a desktop PC (personal computer), a note-type PC, or others. The ordinary user in this context is a user not performing a behavior with a particular intention in the generating process according to the embodiment. A person who specializes in acquisition and analysis of enterprise information such as the company data provider 50, and a person who finances a company are excluded from the ordinary user according to the embodiment. A company may be also excluded from the ordinary user. However, a manager or individual executives of a company may be included in the ordinary user.

The financial institution server 30 is a server device used by a financial institution. More specifically, the financial institution server 30 receives a request for financing from a company, and notifies the company about a result of acceptance or refusal of the request. The financial institution server 30 uses the generating device 100 to evaluate credit to a company at the time of financing of the company.

The web server 40 is a server device providing various types of web pages when accessed by the user terminals 10. For example, the web server 40 provides various types of web pages, such as news sites, weather forecast sites, shopping sites, finance (stock price) sites, route search sites, map supply sites, travel sites, restaurant introduction sites, and weblog sites.

The web server 40 stores user behaviors performed on the network. The user behavior information is stored as user information data 42 in the web server 40 or a predetermined storage device. The user behaviors performed on the network in this context refers to information transmitted from each of the user terminals 10 in accordance with operation by a user at the time of use of a service provided by various types of web sites. For example, the user behaviors on the network include transmission of a search query in a search site, a purchasing behavior in a shopping site, review posting from a user in a product evaluation site. The user behaviors further include exchange of messages in an SNS (social networking service) site, and a following behavior for following another person, for example.

The flow of the generating process executed by the generating system 1 and the generating device 100 is hereinafter described with reference to FIG. 2. Description of the matters already touched upon with reference to FIG. 1 is not repeated.

In the example illustrated in FIG. 2, the generating device 100 initially receives supply of company data 52 possessed by the company data provider 50 (step S11). The company data 52 includes information presented to the public as financial information, and information investigated by an investigator belonging to the company data provider 50. The company data 52 further includes information about a company score calculated by the company data provider 50.

The generating device 100 further acquires the user information data 42 transmitted from the web server 40 (step S12). The generating device 100 acquires, as the user information data 42, information concerning a company, corresponding to user behaviors performed on the Internet, and available via the Internet. More specifically, the generating device 100 acquires, as the user information data 42, information about the number of times of search behaviors performed by each of the user terminals 10 as search queries for searching the name of the company or product names or the like supplied by the company, the number of visits to a website provided by the company, reviews posted for products supplied by the company, and others.

The generating device 100 analyzes a correlation between respective sets of the acquired information (step S13). For example, the generating device 100 analyzes correlation and correspondence between a score calculated by the company data provider 50 and the user information data 42 acquired via the Internet. Then, the generating device 100 generates a credit model for outputting a score of the company by using the method described with reference to FIG. 1 (step S14).

The generating device 100 receives an inquiry about credit information of a predetermined company from the financial institution server 30 (step S15). When receiving a request for financing from a predetermined company, for example, the financial institution server 30 inquires the generating device 100 about credit information concerning the predetermined company to acquire the credit information about the predetermined company. The predetermined company in this context is a small or middle-scale enterprise whose score is not contained in the company data provided by the company data provider 50. In this case, the generating device 100 acquires information concerning the predetermined company and available on the network, and inputs the acquired information to the model to calculate a score of the predetermined company. In other words, the generating device 100 calculates credit information concerning the predetermined company (step S16).

The generating device 100 transmits the calculated credit information to the financial institution server 30 (step S17). The flow of a series of these processes allows the generating device 100 to supply credit information concerning a company to the financial institution server 30.

### 2. Configuration of Generating Device

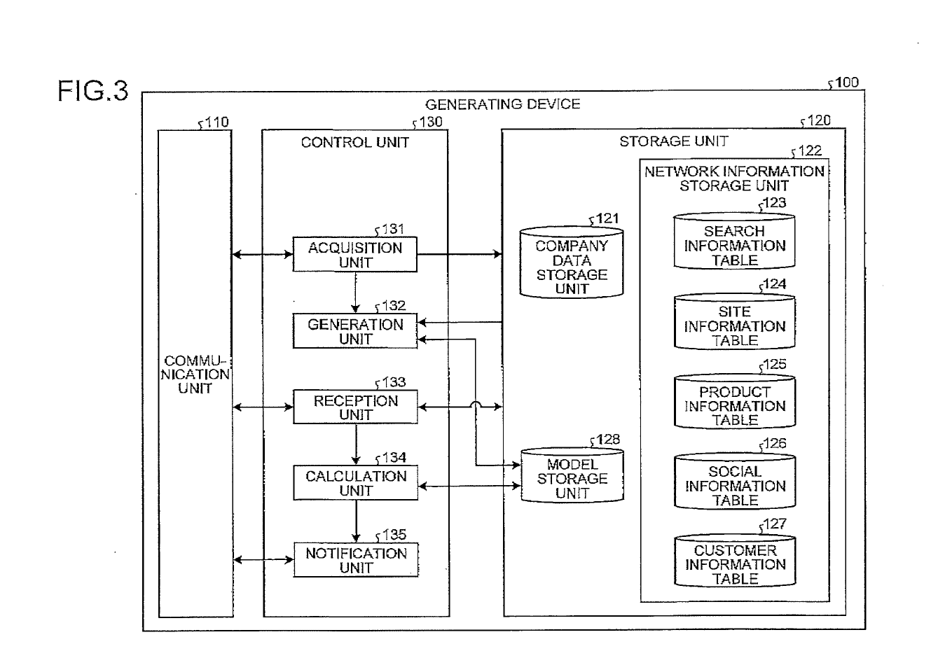

A configuration of the generating device 100 according to the embodiment is hereinafter described with reference to FIG. 3. FIG. 3 is a view illustrating a configuration example of the generating device 100 according to the embodiment. As illustrated in FIG. 3, the generating device 100 includes a communication unit 110, a storage unit 120, and a control unit 130. The generating device 100 may further include an input unit for receiving various types of operations from a manager or the like using the generating device 100 (such as keyboard and mouse), and a display unit for displaying various types of information (such as liquid crystal display).

Communication Unit 110

The communication unit 110 is realized by an NIC (network interface card) or the like. The communication unit 110 is connected with the communication network via wired or wireless communication, and transmits and receives information to and from the user terminals 10 or others via the communication network.

Storage Unit 120

The storage unit 120 is realized by a semiconductor memory device such as a RAM (random access memory) and a flash memory, or a storage device such as a hard disk and an optical disk. The storage unit 120 according to the embodiment includes a company data storage unit 121, a network information storage unit 122, and a model storage unit 128. The respective storage units are hereinafter sequentially described.

Company Data Storage Unit 121

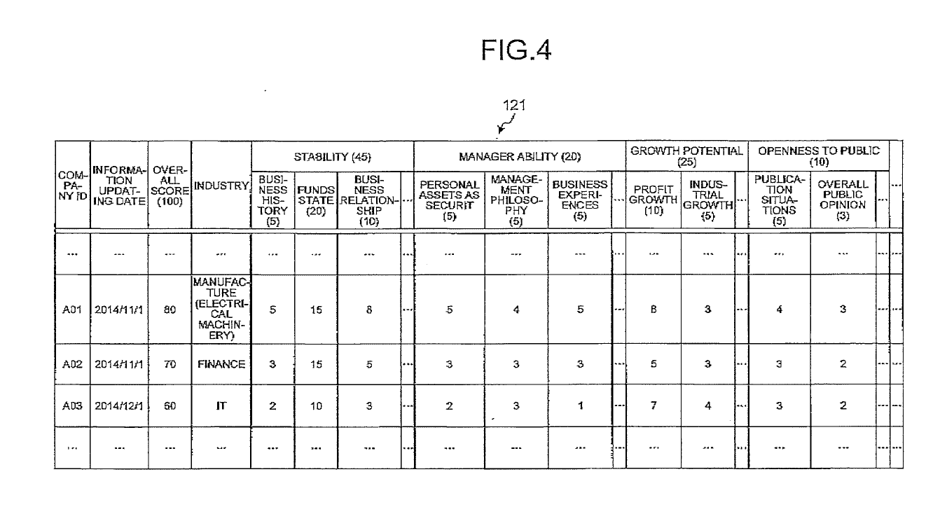

The company data storage unit 121 stores information about company data provided by the company data provider 50. FIG. 4 illustrates an example of the company data storage unit 121 according to the embodiment. As illustrated in FIG. 4, the company data storage unit 121 includes items of “company ID”, “information updating date”, “overall score”, “industry”, “stability”, “manager ability”, “growth potential”, and “openness to public”. Respective numerals entered after the respective items indicate the maximum scores given by the company data provider 50.

The “company ID” indicates identification information for identifying a company. The “information updating date” indicates a date when information concerning the company is updated. For example, the information updating date indicates a date for update of a score of the company calculated by the company data provider 50 (once per month, for example).

The “overall score” indicates an overall score of the company calculated by the company data provider 50. According to the example illustrated in FIG. 4, the overall score is the sum of the scores for the respective items of the stability, manager ability, growth potential, openness to the public and others. The “industry” indicates a category of the industry or business to which the company belongs.

The “stability” is one of the items for evaluating the company, corresponding to an item for evaluating whether or not the company is capable of continuing stable management, such as business continuation of the company. The item of “stability” includes small items of “business history”, “funds current state”, “business relationship” and others. A score given by the company data provider 50 is entered into each of the small items. For example, the company data provider 50 may determine superiority or inferiority of the business record of the company in view of the business history, and give a score based on an original model. Alternatively, the company data provider 50 may give a score from a personal viewpoint of the investigator or the like. The item of “stability” may include small items such as a capital adequacy ratio, a collateral margin, and a financial result of the company as well as the small items illustrated in FIG. 4.

The “manager ability” is one of the items for evaluating the company, corresponding to an item for evaluating the ability of the manager such as the career and personality of the manager of the company. The item of “manager ability” includes small items such as “personal assets as security”, “management philosophy”, and “business experiences”. A score calculated by the company data provider 50 based on a model, or a score given from a personal viewpoint is entered into each of the small items, similarly to the item of “stability”. The small items included in the item of “manager ability” are not limited to the examples illustrated in FIG. 4, but may include health conditions of the company, the presence or absence of a successor, personal connections and the like.

The “growth potential” is one of the items for evaluating the company, corresponding to an item for evaluating an expectation value for progress in management of the company in the future or others. The item of “growth potential” includes small items such as “profit growth” and “industrial growth”. A score calculated by the company data provider 50 based on a model, or a score given from a personal viewpoint is entered into each of the small items, similarly to the item of “stability”. The small items included in the item of “growth potential” are not limited to the small items illustrated in FIG. 4, but may be marketability of commodities supplied by the company, enterprise vitality, and other small items.

The “openness to public” is one of the items for evaluating the company, corresponding to an item for evaluating an attitude of the company toward information publication or the like. The item of “openness to public” includes small items of “publication situations”, “overall public opinion” and others. A score calculated by the company data provider 50 based on a model, or a score given from a personal viewpoint is entered into each of the small items, similarly to the item of “stability”. For example, it is assumed that the soundness of the management of a company increases as the company opens more detailed financial information and stock information to customers and stockholders. Accordingly, the company data provider 50 gives a high score to such a sound company. The small items included in the item of “openness to the public” are not limited to the small items illustrated in FIG. 4, but may be marketability of commodities supplied by the company, enterprise vitality, and other small items.

FIG. 4 illustrates an example of stored information updated on “Nov. 1, 2014” for a company identified as a company ID “A01”, including an overall score of “80”, an industry of “manufacture (electrical machinery)”, scores for respective items as “5” for business history, “15” for funds current state, “8” for business relationship, “5” for personal assets as security, “4” for management philosophy, “5” for business experiences, “8” for profit growth”, “3” for industrial growth, “4” for openness state, and “3” for overall public opinion.

In the following description, the identification information stored in the “company ID” as illustrated in FIG. 4 may be used as a reference number. For example, the company identified by the company ID “A01” may be expressed as “company A01”.

Network Information Storage Unit 122

The network information storage unit 122 stores user information acquired via the communication network. More specifically, the network information storage unit 122 stores information available on the communication network and concerning a company. As illustrated in FIG. 3, the network information storage unit 122 includes a search information table 123, a site information table 124, a product information table 125, a social information table 126, and a customer information table 127. The respective data tables are hereinafter sequentially described.

Search Information Table 123

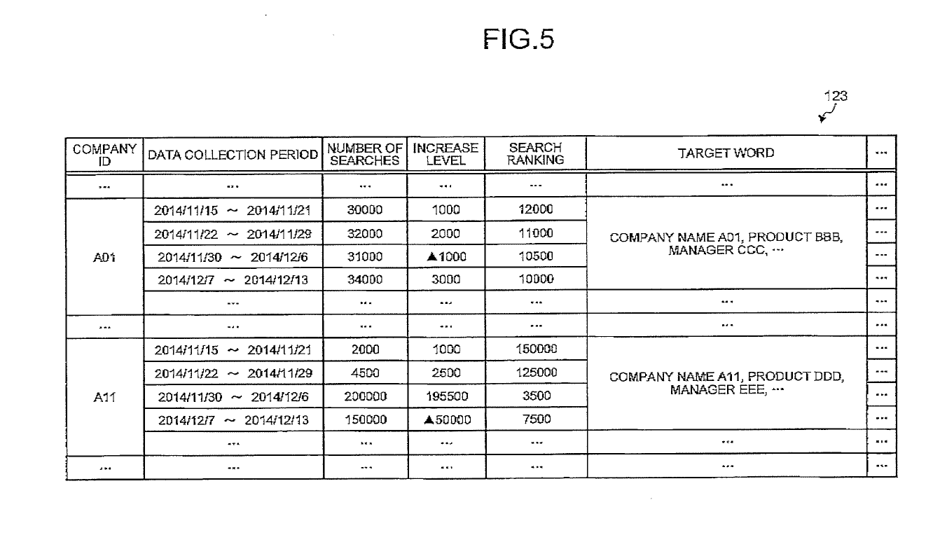

The search information table 123 stores information associated with search behaviors of a user performed on the Internet. FIG. 5 illustrates an example of the search information table 123 according to the present embodiment. As illustrated in FIG. 5, the search information table 123 includes items such as “company ID”, “data collection period”, “number of searches”, “increase level”, “search ranking”, and “target word”.

The “company ID” indicates identification information for identifying a company. The “data collection period” indicates a period for collecting data of search behaviors performed by each of the user terminals 10. While the data collection period is set to the unit of one week in the example of FIG. 5, the data collection period may be a period other than one week. For example, when the data collection period is set to one month, the generating device 100 is capable of easily recognizing a tendency of searches in a longer period.

The “number of searches” indicates the number of times of search for a company performed in a predetermined search site by using a search engine. Search queries counted as the number of searches are not limited to queries containing the name of the company, but may contain the names of products supplied by the company, the name of the manager of the company, or others, as will be described below.

The “increase level” indicates increase or decrease in the number of searches in comparison with data obtained in the immediately preceding data collection period. The “search ranking” indicates ranking based on the number of searches in the predetermined search site. While not shown in the figure, items of the search ranking may include not only ranking based on the number of searches, but also ranking based on the increase level.

The “target word” indicates a word counted as a search for a company when a word entered as a target word is transmitted as a search query. When a name of a product supplied by a company is better known than the name of the company, for example, the user may perform a search based on the name of the product. In this case, a search based on the name of the product in a search query is counted as a search for the company supplying the corresponding product when the name of the product is set to a target word. The target word may be personally set by the manager of the generating device 100 or based on a request from a company, or may be automatically set through analysis of links of websites based on a search result, for example. More specifically, when a number of websites associated with the “company name A01” are displayed as a result of search for a “product BBB”, the “product BBB” is automatically set as a target word as well as the company name A01.

FIG. 5 illustrates an example of data indicating that the company identified by the company ID “A01” is searched “30,000 times” during a data collection period “from Nov. 15, 2014 to Nov. 21, 2014”, with increase of “1,000 times” from the immediately previous number of searches, and “12,000th” search ranking. Target words set to the company A01 are “company name A01”, “product BBB”, and “manager CCC”, for example.

According to another example, a company A11 is searched “200,000 times” during a data collection period “from Nov. 30, 2014, to Dec. 6, 2014”, with “195,500 times” increase in the number of searches. It is assumable from this data that the company A11 has suddenly become known as a result of a certain event. In this case, the search information table 123 may store a mark put on the company A11 to recognize the company A11 as a notable company, for example, based on the rapid increase level. This mark may be used for generation of a model (described below), for example.

Site Information Table 124

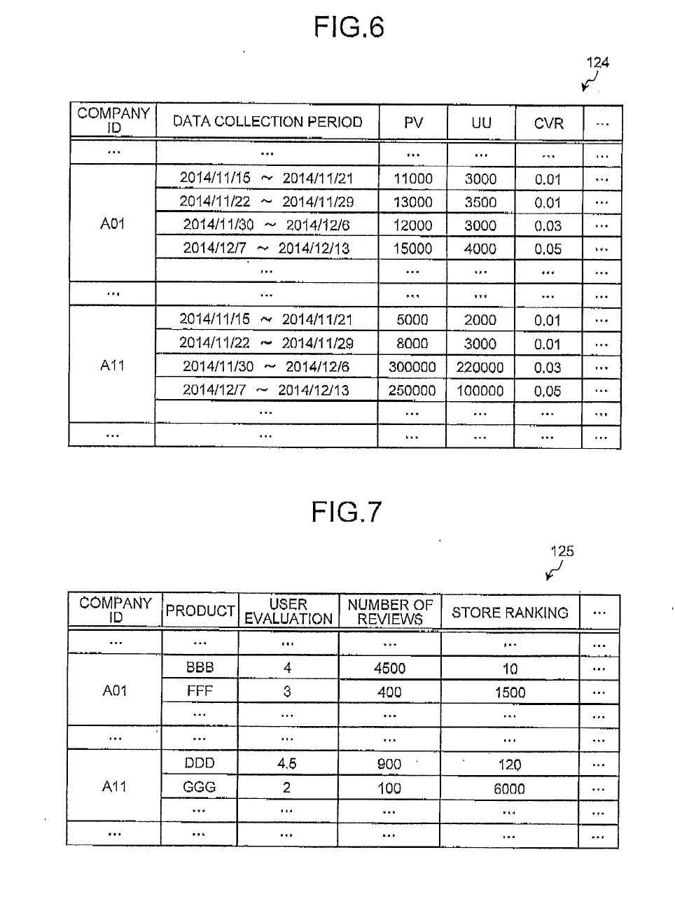

The site information table 124 stores information about a website operated or managed by a company. FIG. 6 illustrates an example of the site information table 124 according to the embodiment. As illustrated in FIG. 6, the site information table 124 includes items of “company ID”, “data collection period”, “PV”, “UU”, and “CVR”, for example.

The “company ID” and “data collection period” correspond to the similar items stored in the search information table 123. The “PV” indicates page views in the website, i.e., the number of views.

The “UU” indicates the number of unique users. The unique users in this context indicate the number of persons visiting the website. An identical user is counted as a UU number of “1” even when this user visits the same website several times.

The “CVR” indicates a conversion ratio. The CVR indicates a ratio of conversion to the number of views of the website. The conversion in this context refers to a final achievement allowed in the website. For example, conversion includes purchase of goods in an online shopping site, member registration in an information providing site or a community site, and requests for information materials. The CVR may be a ratio of conversion to the number of views, or a ratio of conversion to the unique users.

FIG. 6 illustrates an example of data indicating that the website provided by the company A01 is viewed “11,000 times” during a data collection period “from Nov. 15, 2014 to Nov. 21, 2014”. The number of UUs having viewed the website is “3,000”, and conversion is achieved at a ratio of “1 percent” to the number of views.

The data collection period shown in FIG. 6 is presented only by way of example. The PV or the like counted by the unit of one week in this example may be counted by the unit of one day or one month, for example. While absolute values are entered into the items such as the PV in this example, fluctuations from the immediately preceding data collection period may be counted for the respective items.

Product Information Table 125

The product information table 125 stores information about a product supplied by a company. FIG. 7 illustrates an example of the product information table 125 according to the embodiment. As illustrated in FIG. 7, the product information table 125 includes items of “company ID”, “product”, “user evaluation”, “number of reviews”, and “store ranking”, for example.

The “company ID” corresponds to the similar item stored in the search information table 123. The “product” indicates a name of a product supplied by the company.

The “user evaluation” indicates a value of evaluation given by an ordinary user in a product evaluation site on the Internet. The product evaluation site in this context is a community site for receiving review information such as reviews and evaluations of products from ordinary users. When the product supplied by the company is an application for terminals, a site providing application download services (called application store, for example) may function as a product evaluation site as well. In this example, the user evaluation is indicated by an average of numerical values from “0” to “5” transmitted from users.

The “number of reviews” indicates the number of reviews posted by users in the product evaluation site on the Internet. The “store ranking” indicates ranking of the product in similar types of products handled in the product evaluation site. The store ranking may be determined based on numerical values of user evaluations, or based on the number of sales of the product. When the product evaluation site is an application store as in the foregoing case, the store ranking may be ranking based on the number of downloads of the corresponding application.

FIG. 7 illustrates an example of data indicating that the product “BBB” supplied by the company A01 is given a user evaluation of “4”, with the number of posted reviews of “4,500”, and store ranking of “10th”.

Social Information Table 126

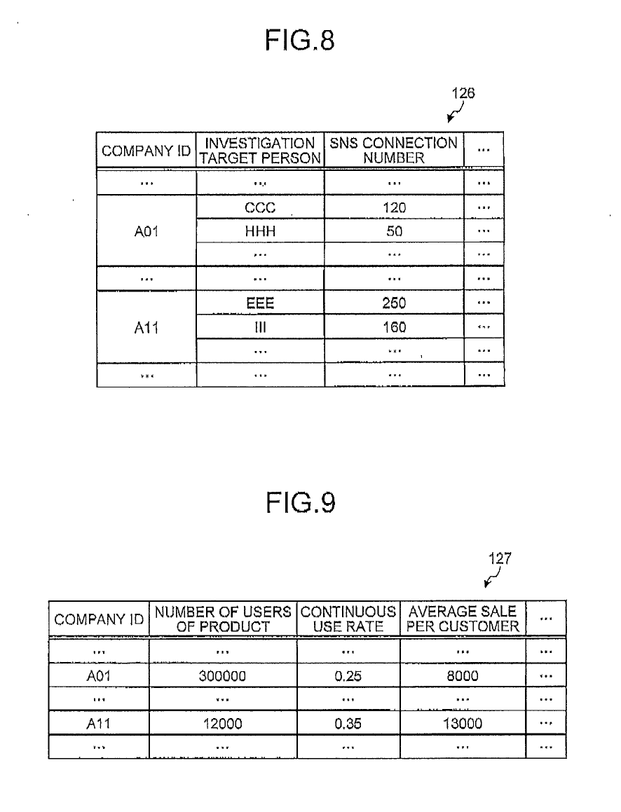

The social information table 126 stores index values for evaluating social reputations and personal connections of a company. More specifically, the social information table 126 stores information acquired from an SNS site used by a manager or executives of a company. FIG. 8 illustrates an example of the social information table 126. As illustrated in FIG. 8, the social information table 126 includes items of “company ID”, “investigation target person”, and “SNS connection number”, for example.

The “company ID” corresponds to the similar item stored in the search information table 123. The “investigation target person” indicates a name of a person corresponding a social analysis target. For example, the investigation target person includes a manager, a president, and executives such as directors in a certain company.

The “SNS connection number” indicates a numerical value of connections with other persons in an SNS when the investigation target person uses the SNS. For example, the “SNS connection number” corresponds to the number of followers of each person on an SNS. The SNS connection number may exclude the number of ordinary users, and contain only the number of connections between managers or executives in different companies. In this case, the SNS connection number may become a more reliable index value indicating personal connections of the investigation target person.

FIG. 8 illustrates an example of data indicating that investigation target persons of the company A01 are “CCC” and “HHH”. The connection number of the “CCC” in an SNS used by the “CCC” is “120”, while the connection number of the “HHH” in an $N$ used by the HHH is “50”.

Customer Information Table 127

The customer information table 127 stores information about customers of a company. FIG. 9 illustrates an example of the customer information table 127 according to the embodiment. As illustrated in FIG. 9, the customer information table 127 includes items of “company ID”, “number of users of product”, “continuous use rate”, and “average sale per customer”, for example.

The “company ID” corresponds to the similar item stored in the search information table 123. The “number of users of product” indicates the number of customers using a product supplied by a company. For example, when the product supplied by the company is an application, the “number of users of product” corresponds to the total number of downloads of the application supplied by the company.

The “continuous use rate” indicates a rate of continuous use of a company by customers. When a company operates a shopping site on the Internet, for example, the “continuous use rate” corresponds to a ratio of the number of users regularly using the site to the total number of users viewing the site. When a company supplies an application, the continuous use rate may be the number of user terminals 10 confirmed as terminals continuously using the application with respect to the total number of downloads. In this case, the continuous use rate is stored as a rate of operation of the application (value obtained by dividing the number of users in a predetermined period by the number of download users).

The “average sale per customer” indicates an average sale per customer. When a company provides a shopping site, for example, the average sale per customer corresponds to the sum of purchase amounts per user in a predetermined period. When a company supplies an application, the average sale per customer may be calculated based on an amount of download sales of the application, or a cost for continuous use of the application.

FIG. 9 illustrates an example of data indicating that the number of users of a product supplied by the company A01 is “300,000”, with a continuous use rate of “0.25”, and an average sale per customer of “8,000 yen”.

Model Storage Unit 128

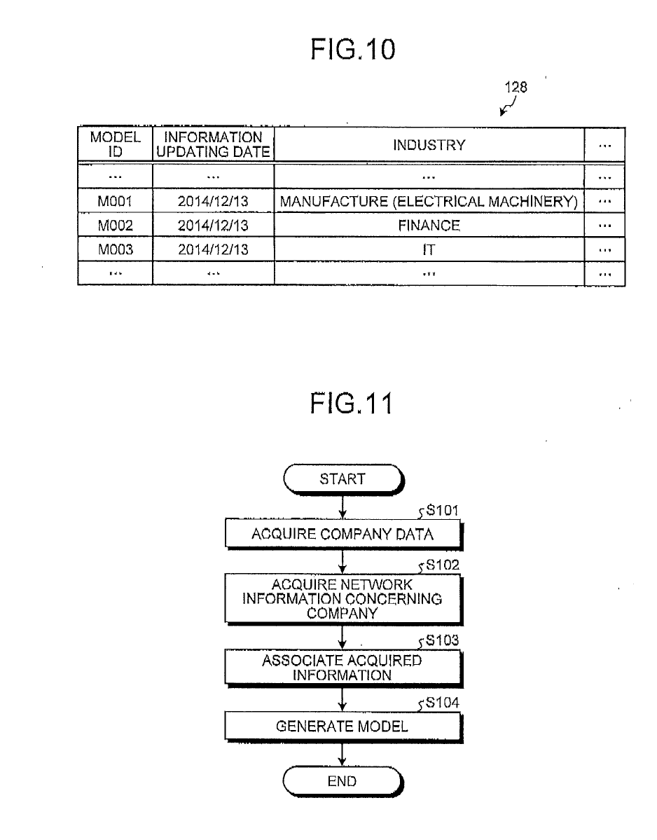

The model storage unit 128 stores information about a model generated by the generating device 100. FIG. 10 illustrates an example of the model storage unit 128 according to the embodiment. As illustrated in FIG. 10, the model storage unit 128 includes items of “model ID”, “information updating date”, and “industry”, for example.

The “model ID” indicates identification information for identifying a model. The “information updating date” indicates a date of update of the model. The “industry” indicates an industry to which a score calculation target company belongs. According to this structure, a model is produced for each industry of companies. In other words, a model is produced by using company data concerning a predetermined identical industry. This structure is adopted for generation of a model so that commonality or similarity of numerical values can be easily recognized in each of comparison target items based on company data concerning an identical industry.

FIG. 10 illustrates an example of data indicating that information about a model M001 is updated on “Dec. 13, 2014”, and that the model M001 belongs to an industry of “manufacture (electrical machinery)”.

Control Unit 130

The control unit 130 is realized by a CPU (central processing unit), an MPU (micro processing unit) or the like which executes various types of programs (corresponding to an example of search program) stored in a storage device contained in the generating device 100 while using the RAM as a work area. The control unit 130 is realized by an integrated circuit such as ASIC (application specific integrated circuit) and FPGA (field programmable gate array), for example.

As illustrated in FIG. 3, the control unit 130 according to the embodiment includes an acquisition unit 131, a generation unit 132, a reception unit 133, a calculation unit 134, and a notification unit 135. The control unit 130 realizes or executes functions and operations for information processing described below. The internal configuration of the control unit 130 is not limited to the configuration illustrated in FIG. 3, but may be other configurations as long as execution of the information processing described below is allowed. The connecting relation between respective processing units included in the control unit 130 is not limited to the connecting relation illustrated in FIG. 3, but may be other connection relations.

Acquisition Unit 131

The acquisition unit 131 acquires information concerning a company from information transmitted on a communication network (such as the Internet). For example, the acquisition unit 131 acquires information concerning a company and based on user behaviors performed on the Internet. More specifically, the acquisition unit 131 according to the embodiment specifies a company corresponding to a sample of model generation, and searches for information concerning the specified company on the Internet. Then, the acquisition unit 131 acquires, from the web server 40, information transmitted from users during use of services provided from various types of websites and associated with the company, as information based on the user behaviors performed on the Internet. The information based on the user behaviors performed on the Internet in this context refers to information generated in accordance with use of services by users in various types of websites, such as a search query transmitted by a user through a search site, a review of a product posted by a user in a product evaluation site, and publication of information by a user in an SNS. The service associated with the company in this context is not limited to a service of a shopping site or the like directly provided by the company, but includes a service provided from a search site through which a company is searchable, and a service provided from an evaluation site for evaluating a product of a company, for example.

The acquisition unit 131 acquires search information concerning a company from a predetermined search site, for example. More specifically, the acquisition unit 131 acquires search information indicating how many times a company has been searched by a user, for example, based on a search query concerning the company as a search target word. The acquisition unit 131 stores the acquired information in the search information table 123.

The acquisition unit 131 acquires site information from a website provided by a company corresponding to an information acquisition target. More specifically, the acquisition unit 131 acquires information about the PV number, UU number, and CVR from the website provided by the company. The acquisition unit 131 stores the acquired information in the site information table 124.

The acquisition unit 131 acquires information about products supplied by a company corresponding to an information acquisition target. More specifically, the acquisition unit 131 acquires information available on the Internet and indicating user evaluations, the number of reviews, store ranking or the like of the products supplied by the company. The acquisition unit 131 may acquire information about tendencies of respective sets of information (i.e., rate of fluctuations), such as a fluctuation of user evaluations, and a fluctuation of store ranking. When the product provided by the company is a program product such as an application, the acquisition unit 131 acquires index values such as the number of downloads of the application, the number of users, the average use time per user, and the rate of operation of the application in a predetermined period. The acquisition unit 131 stores the acquired information in the product information table 125. The acquisition unit 131 acquires information for evaluating social reputations or attractiveness of a company corresponding to an information acquisition target.

More specifically, the acquisition unit 131 acquires information about the number of connections of a manager or executives of a company in an SNS. For example, the acquisition unit 131 may acquire personal movements of a manager performed on the Internet as an index value for evaluating social reputations or attractiveness of the manager. For example, the acquisition unit 131 acquires information about a person having a personal connection with the manager on an SNS (such as information about name value of the person and company scale owned by the person). In other words, the acquisition unit 131 acquires information assumed to indicate personal connections of the manager, for example. The acquisition unit 131 may acquire the number of accesses to a manager or individual executives of a company from ordinary users, and the number of followers in an SNS of the manager or individual executives of the company as information about the name value or reputations of the manager or the individual executives of the company, separately from the number of connections in the SNS described above. The acquisition unit 131 stores the acquired information in the social information table 126.

The acquisition unit 131 acquires information about customers of a company corresponding to an information acquisition target. More specifically, the acquisition unit 131 acquires information about the number of users of products supplied by a company, a rate of continuous use by users, an average sale per customer or the like. For example, when a company supplies an application, the acquisition unit 131 acquires the number of users of the product based on the number of downloads of the application from an application store. When a company operates a shopping site, the acquisition unit 131 acquires information about a rate of continuous use and an average sale per customer based on intervals of visits by users to the site, or information about amounts of purchase, for example. The acquisition unit 131 stores the acquired information in the customer information table 127.

The acquisition unit 131 may randomly acquire information about various companies without specifying a company corresponding to an information acquisition target. For example, the acquisition unit 131 utilizes a program such as a search robot used by a search engine or the like, and allows the program to crawl on the Internet to acquire information about a company or update the acquired information as necessary.

Generation Unit 132

The generation unit 132 generates a model for calculating credit to a company based on various types of information. More specifically, the generation unit 132 according to the embodiment generates a model for outputting credit to a company as a score based on network information acquired by the acquisition unit 131, an existing model possessed by the company data provider 50, and a score calculated by using this existing model. In the following description, companies A01 through A03, or a company A11 illustrated in FIGS. 5 through 9 are discussed as examples of companies corresponding to processing targets.

For example, the generation unit 132 generates a model for predicting a score indicating credit to the company A11 not scored by the company data provider 50, based on information acquired by the acquisition unit 131 and concerning the company A11, in consideration of a correlation between information acquired by the acquisition unit 131 and concerning the company A01 and a score of the company A01 given from the company data provider 50. In addition, the generation unit 132 generates a model based on a correlation between scores of respective items constituting the score given by the company data provider 50 and sets of information concerning the company A01 and associated with the respective items. For example, sets of information concerning the company A01 and included in search information illustrated in FIG. 5, site information illustrated in FIG. 6, and product information illustrated in FIG. 7 are associated with the item of “stability”.

More specifically, the generation unit 132 associates information indicating whether or not the company A01 is searched a certain number of times by users for a predetermined period, whether or not a website provided by the company A01 is viewed a certain number of time or more, or a rate of change of these numerical values, for example, with the information for measuring the stability of the company A01.

The generation unit 132 may receive personal input from the manager or the like of the generating device 100 for association of the foregoing information. For example, the manager of the generating device 100 associates search information or the like with the item of “stability” as discussed above. The manager of the generating device 100 may arbitrarily associate search information or customer information with the item of “growth potential”. During a generating process of a model executed as described below, the generation unit 132 adopts information having an appropriate correlation, and changes information having an inappropriate correlation based on which useful scores are difficult to obtain. By this method, the generation unit 132 optimizes the model to be generated.

The generation unit 132 generates a model through regression analysis of scores of the respective items constituting the score given by the company data provider 50, and quantified information concerning the company A01 and associated with the respective items.

More specifically, the generation unit 132 performs regression analysis of the scores of the respective items constituting the score given by the company data provider 50 corresponding to correct answer data, and values indicated by variables corresponding to quantified information acquired by the acquisition unit 131 (such as quantified information about the number or searches, ranking of product evaluation, the number of product users or the like for comparison with correct answer data) to generate a model for outputting a score of a company. For example, the generation unit 132 obtains a coefficient for calculating scores of respective items by using a following linear expression of Expression (1).

y=α·x+β (1)

In Expression (1), “y” indicates a score given by the company data provider 50 as correct answer data. In Expression (1), “x” indicates a variable corresponding to quantified information acquired by the acquisition unit 131. In Expression (1), “α” indicates a coefficient of “x”, while “β” indicates a numeral for complementing the relation between “y” and “α·x”. In this case, “y” is a numerical value indicating the item of “stability” of the company A01, and assumed as “25”. In addition, “x” indicates network information about the company A01, corresponding to quantified information about the number of searches, for example. Association of these types of information and quantification are optimized with progress in regression analysis. For example, the generation unit 132 initially sets an arbitrary conditional expression for the number of searches of “30,000” for the company A01 in a predetermined period, and gives an arbitrary numerical value such as “10”. Then, the generation unit 132 appropriately changes the initial conditional expression in the process of calculation of the correlation between the given arbitrary numerical value and the correct answer data. By this method, the generation unit 132 obtains an optimized numerical value.

The generation unit 132 forms an expression by substituting numerical values for “y” and “x” of Expression (1). The generation unit 132 executes similar processes for the company A02 and the company A03. The generation unit 132 determines “α” and “β” by repeating these processes. Alternatively, “α” and “β” may be approximated by optimum answers using a least squares method, for example. The plurality of variables “x” may be used. For example, the generation unit 132 may approximate various combinations of sets of company information available on the network by the score of the company data provider 50. For example, the generation unit 132 may use following Expression (2).

y=α₁·x₁+α₂·x₂+α₃·x₃+ . . . +αₙ·xₙ+β (2)

The generation unit 132 may obtain variables and coefficients “α₁ through αₙ” approximated by the score of the company data provider 50 corresponding to correct answer data based on variables “x₁ through xₙ n: arbitrary numeral)” as expressed in Equation (2).

The generation unit 132 may change types of information concerning the company A01 and associated with the respective items constituting the score of the company data provider 50 based on a result of regression analysis. More specifically, when information of a type different from the quantified information about the “number of searches” of the company A01 is more easily approximated by the correct answer data, the generation unit 132 determines the information of the different type as information to be associated with the item of “stability”. By this method, the generation unit 132 optimizes the type of network information used as a model.

According to this example, the model generated by the generation unit 132 for outputting a score for the item of “stability” has been discussed. The generation unit 132 also executes these processes for the “manager ability”, “growth potential”, and “openness to the public” to generate a model for calculating an overall score of a company.

The generation unit 132 may appropriately adjust the predetermined period of information used for generation of a model. For example, the number of searches, the number of PVs of a website or the like is rapidly variable in accordance with effects of positive materials (such as news reports on development of noticeable products) or negative materials (such as news reports on disclosure of injustice). These effects decrease when the generation unit 132 uses information about the number of searches or the like in a longer period than the ordinary period. Determination of this period may be manually made by the manager of the generating device 100, or automatically made based on analysis of words contained in the news articles, for example.

The generation unit 132 may use information stored in the network information storage unit 122 as necessary, in addition to the number of searches discussed above or the like. For example, the generation unit 132 may use analysis of product information, analysis of social relations of a company, customer analysis or other information. For example, the generation unit 132 associates information about supply of a large number of products receiving high evaluations from users with the items of business continuation and growth potential. More specifically, the generation unit 132 adjusts values of quantified variables based on values of evaluations of users, the number of reviews, and store ranking stored in the items in the product information table 125. Alternatively, the generation unit 132 may use the number of downloads, the number of users, the average use time per user, the rate of operation in a predetermined period of applications, or the rate of fluctuations of these numerical values in a predetermined period, for example.

The generation unit 132 may generate a model by using information concerning a company belonging to an identical industry. For example, it is assumed that appropriate information about product reviews or the like is obtainable not by comparison between products in different industries, but by comparison between products in an identical industry. Accordingly, the generation unit 132 classifies companies into respective industries and generates a model for each of the industries. In this case, the calculation unit 134 (described below) calculates a score by using a model in the industry corresponding to the industry of a processing target. FIG. 10 illustrates an example in which the generation unit 132 generates a model for each industry, and stores the respective models in the model storage unit 128.

Reception Unit 133

The reception unit 133 receives a request for obtaining credit to a company. More specifically, the reception unit 133 according to the embodiment receives, from the financial institution server 30, an inquiry about credit information concerning a company and used for setting of financing conditions or the like. In this case, the reception unit 133 may receive information about the company together with the request. For example, the reception unit 133 receives the name of the company, information about products supplied by the company, information concerning the type of business, manager, and executives of the company, and others. Then, the reception unit 133 transmits the received information to the calculation unit 134 (described below) to calculate a score of the company. The reception unit 133 may acquire new information from an external information processing device (such as web server 40) when the reception unit 133 does not receive the information about the products supplied by the company or information about the manager or executives from the financial institution server 30 not having received these sets of information yet, or when these sets of information are not stored in the network information storage unit 122. The reception unit 133 transmits the received information to the calculation unit 134.

Calculation Unit 134

The calculation unit 134 calculates credit to a company. More specifically, the calculation unit 134 according to the embodiment inputs information concerning a company received by the reception unit 133 to a model generated by the generation unit 132 to output a score of the company corresponding to a process target. Then, the calculation unit 134 calculates credit to the company based on the output score. The calculation unit 134 may use the output score as credit to the company.

For example, the calculation unit 134 acquires network information about the company A11 when the reception unit 133 receives a request for obtaining credit to the company A11. Subsequently, the calculation unit 134 inputs the network information about the company A11 to a model generated by the generation unit 132. Then, the calculation unit 134 acquires a score of the company A11 as output. When a model corresponding to an industry to which the company A11 belongs exists in the model storage unit 128, the calculation unit 134 may preferentially use this model corresponding to the industry to calculate a score.

Notification Unit 135

The notification unit 135 gives a notification of a reply to a received request. More specifically, the notification unit 135 according to the embodiment gives a notification of credit (credit information) such as a score of a company corresponding to an evaluation target, in response to a request received by the reception unit 133 from the financial institution server 30.

### 3. Process Procedure

A generating process procedure executed by the generating device 100 according to the embodiment is hereinafter described with reference to FIG. 11. FIG. 11 is a flowchart illustrating the generating process procedure executed by the generating device 100 according to the embodiment.

As illustrated in FIG. 11, the acquisition unit 131 of the generation device 100 acquires, from the company data provider 50, company data containing a score of a company given by the company data provider 50 (step S101). The acquisition unit 131 further acquires network information concerning the company via the Internet (step S102).

The generation unit 132 executes an associating process for associating the acquired information (step S103). More specifically, the generation unit 132 associates information about items constituting the company data with information available on the Internet and concerning the company.

The generation unit 132 generates a model for outputting a score of the company when information concerning the company on the Internet is input (step S104). The generation unit 132 stores the generated model in the model storage unit 128, and ends the generating process.

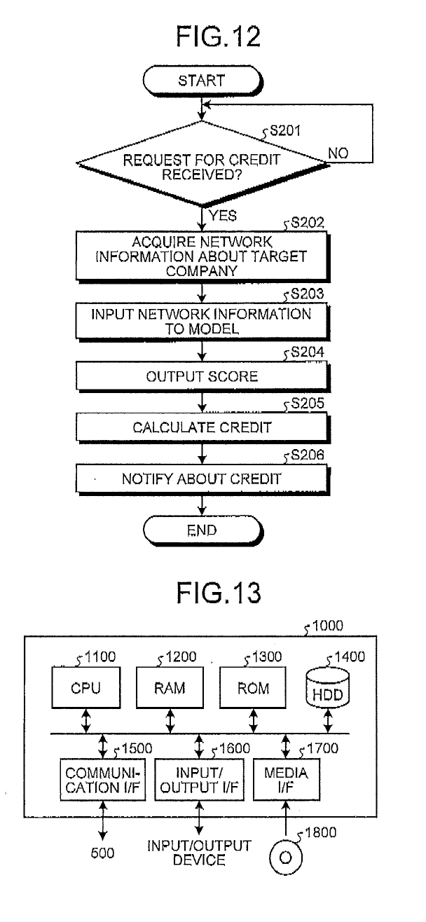

A calculating process procedure executed by the generating device 100 according to the embodiment is hereinafter described with reference to FIG. 12. FIG. 12 is a flowchart illustrating the calculating process executed by the generating device 100 according to the embodiment.

As illustrated in FIG. 12, the reception unit 133 of the generating device 100 determines whether or not a request for obtaining credit has been received from the financial institution server 30, for example (step S201). When it is determined that the request has not been received, the reception unit 133 waits until reception of the request (step 3201; No).

When it is determined that the request has been received (step S201; Yes), the reception unit 133 acquires network information of a company corresponding to a calculating process target (step S202). Then, the calculation unit 134 inputs the network information concerning the company acquired by the reception unit 133 to a model (step S203).

The calculation unit 134 executes the calculating process based on the model to output a score of the company (step S204). The calculation unit 134 calculates credit to the company based on the output score (step S205). The notification unit 135 notifies the financial institution server 30 about a calculated result (step S206), and ends the calculating process.

### 4. Modified Examples

The generating device 100 according to the embodiment may be realized in various modes other than the embodiment discussed above. The generation device 100 in modes other than the mode described above is hereinafter sequentially described.

### 4-1. Use of Information about Person Concerned

According to the foregoing embodiment, the generating device 100 generates a model by using information about name values or personal connections of a manager or executives of a company. The generating device 100 may further acquire information from an SNS used by a manager or individual executives of a company, for example, to use the information for generation of a model.

For example, the acquisition unit 131 acquires information about purchase behaviors of the manager or individual executives of the company from the SNS. In this case, the acquisition unit 131 acquires information indicating that the manager or individual executes purchase relatively expensive products, or frequent investment activities from sets of information transmitted to the SNS from the manager or individual executives. Then, the generation unit 132 utilizes the acquired activity information about the manager or individual executives as quantified information corresponding to the network information about the company for the purpose of generation of a model. For example, the generation unit 132 determines that the company is in a more preferable management condition based on higher frequency of purchase activities or investment activities of the manager or individual executives, and sets a favorable value to this information.

The acquisition unit 131 may acquire information about persons having connections with the manager or individual executives of the company in the SNS used by the manager or individual executives (connected persons in the SNS). For example, the acquisition unit 131 acquires information about positions of persons connected with the manager or individual executives of the company, scales or management conditions of enterprises associated with the persons, name values and connections of the persons, and positions of previous jobs of the persons. The generation unit 132 determines personal connections of the manager or individual executives of the company based on the number of persons connected with the manager or individual executives of the company, and the foregoing information about the respective persons. Then, the generation unit 132 quantifies network information based on the determined personal connections of the manager or individual executives of the company. Accordingly, the generating device 100 generates a model in accordance with the growth potential of the company measured based on determination of the personal connections of the related persons of the company.

The acquisition unit 131 may acquire information about personnel changes within the company from sets of information transmitted from the SNS used by the manager or individual executives of the company. For example, the acquisition unit 131 acquires information about offers and resignations of jobs in the company. When information about offers and resignations of jobs in the company is frequently transmitted, the generation unit 132 determines that the business continuation is unstable, and lowers the value of the information. When information about offers of jobs and expansion of the scale of the company are observed for a long period, the generation unit 132 determines that the growth potential of the company is expected, and raises the value of the information.

For example, the acquisition unit 131 may adopt a method of registering words or the like assumed as evaluation indexes beforehand for information transmitted over the Internet such as an SNS so as to automatically collect information from the SNS. In addition, the acquisition unit 131 may update words registered beforehand by using machine learning to acquire information expected as accurate evaluation indexes.

### 4-2. Other Companies in Identical Industry

According to the embodiment, the generating device 100 may generate a model by using information indicating tendencies of products of other companies in an identical industry. For example, the generation unit 132 determines that the scale of the overall industry is expanding, or that needs from customers are increasing, for example, based on information about management situations or the like of other companies in the identical industry. More specifically, the generation unit 132 determines that the degree of attention to the overall industry is increasing based on increase in the number of searches or the number of views of websites associated with other companies in the identical industry, for example. In this case, the generation unit 132 generates a model for increasing a score of a company belonging to this industry, based on quantified information in consideration of increase in the number of searches, increase in the number of views of websites and the like associated with other companies in the identical industry, at the time of setting of variables in regression analysis.

### 4-3. Information Amount

According to the embodiment, the generating device 100 generates a model based on various types of information available on the network. The generating device 100 may execute processes only using information acquired from ordinary users of various types of websites and exceeding a certain threshold.

For example, reviews, user evaluations or the like concerning products in product evaluation sites may exhibit biased tendencies when these reviews or evaluations are not provided based on a certain number or more of data. In this case, the generating device 100 may generate a model based on which credit to a company is difficult to accurately calculate due to the presence of data having biased tendencies and affecting regression expressions. For avoiding this problem, the generating device 100 may use reviews or user evaluations transmitted from users as data to be used for the model generating process only when the number of reviews or user evaluations exceeds a certain number. In this case, the generating device 100 generates a model capable of calculating a highly reliable score.

### 4-4. Weight

The generating device 100 may weight particular information in acquired network information. For example, the generating device 100 determines websites showing comments on products made by specialists in particular fields as more reliable sites than evaluation sites receiving posting from ordinary users. More specifically, the generating device 100 may utilize information about reviews or user evaluations of products acquired from websites showing comments on products by specialists, while putting a heavier weight on this information than information available from other ordinary sites. In this case, the generating device 100 generates a model capable of calculating a highly reliable score.

### 4-5. Correction

The generating device 100 may generate a model capable of correcting an output score in accordance with actual economic situations. For example, the generating device 100 classifies respective companies into companies having preferable management condition in a tendency of strong yen, companies not affected by a tendency of yen, and companies having unfavorable management condition in a tendency of strong yen. In this case, the generating device 100 inputs movements of the value of yen in a predetermined period at the time of calculation of a score of a company to generate a model for outputting the score of the company with correction considering a tendency of yen. For reflecting this correction in the generated model, company data is acquired for a long period and accumulated as data indicating interrelation with movements of the value of yen, for example.

### 4-6. Information on Communication Network

According to the embodiment discussed in detail, the generating device 100 acquires information available on the communication network and concerning a company, chiefly based on user behaviors. However, the information on the communication network acquired by the generating device 100 is not limited to the information described in this example.

For example, the generating device 100 may acquire information not associated with behaviors of ordinary users using the communication network, as information available on the communication network and concerning a company. For example, the generating device 100 may acquire information about natural phenomena such as weather information. Specific examples of information acquired by the generating device 100 as information concerning the company include weather information or disaster information available on the network, particularly for a district where a company resides, or weather information or disaster information for a district contained in the name of the company. This information is acquired on the assumption that the management situations of the company changes in the future in accordance with weather conditions or disaster conditions of the district where the company resides. The generating device 100 generates a model for more accurately calculating an evaluation of credit to a company by considering elements derived from weather information.

The generating device 100 may acquire information not associated with a user, such as information indicating a state of a communicative device around a user and uploaded to the communication network (information via so-called “the Internet of Things”) by using a sensor or the like, as well as information transmitted from the user. According to a specific example, the generating device 100 acquires information available on the network and transmitted from products supplied from a predetermined company, indicating that a large number of the products are constantly operating through a wide area. This information is acquired on the assumption that the diffusion rate and operation rate of the products supplied by the company become an index of management stability of the company. The generating device 100 generates a model for more accurately calculating an evaluation of credit to a company by considering elements of information transmitted from various things, as well as information transmitted from a user. As described above, the generating device 100 generates a model based not only on information directly or indirectly associated with a user, but also on various types of information existing on the communication network. Accordingly, the generating device 100 is capable of providing a highly versatile model applicable to a wide variety of target companies.

### 4-7. Others

All or a part of processes described as automatically executed processes in the respective processes in the foregoing embodiment may be manually executed, or all or a part of processes described as manually executed processes may be automatically executed by using a known method. In addition, processing procedures, specific names, information containing various types of data and parameters described or depicted in the foregoing description or figures may be arbitrarily changed unless otherwise indicated.

The respective constituent elements of the respective devices shown in the figures are presented as functional conceptual elements, and not necessarily structured as physically equivalent elements to the corresponding elements depicted in the figures. More specifically, specific modes of dispersion and unification of the respective devices are not limited to those illustrated in the figures. All or a part of the modes may be functionally or physically dispersed or unified for each arbitrary unit in accordance with various loads or use conditions.

For example, information in the storage unit 120 illustrated in FIG. 3 may be retained not by the generating device 100, but by an external storage server or the like. In this case, the generating device 100 accesses the storage server to acquire various types of information stored therein.

In addition, the foregoing generating device 100 may be dispersed into a frontend server which chiefly realizes communication with an external device, such as reception of a request for obtaining credit information about a company, a notification of credit information about a company, and a backend server which executes acquisition of information on the Internet, the generating process and others. In this case, the frontend server at least includes the reception unit 133 and the notification unit 135. The backend server at least includes the generation unit 132.

### 5. Hardware Configuration

The generating device 100 according to the foregoing embodiment is realized by a computer 1000 configured as illustrated in FIG. 13, for example. FIG. 13 is a hardware configuration diagram illustrating an example of the computer 1000 realizing the function of the generating device 100. The computer 1000 includes a CPU 1100, a RAM 1200, a ROM 1300, a HDD 1400, a communication interface (I/F) 1500, an input/output interface (I/F) 1600, and a media interface (I/F) 1700.

The CPU 1100 operates under programs stored in the ROM 1300 or the HDD 1400 to control respective units. The ROM 1300 stores a boot program executed by the CPU 1100 at the time of a start of the computer 1000, a program dependent on the hardware of the computer 1000, and others.

The HDD 1400 stores the programs executed by the CPU 1100, and data or the like used under the programs. The communication interface 1500 receives data from another device via a communication system 500 (corresponding to communication network in the embodiment), and transmits the data to the CPU 1100. The communication interface 1500 also transmits data generated by the CPU 1100 to another device via the communication system 500.

The CPU 1100 controls output devices such as a display and a printer, and input devices such as a keyboard and a mouse via the input/output interface 1600. The CPU 1100 acquires data from the input device via the input/output interface 1600. The CPU 1100 outputs generated data to the output device via the input/output interface 1600.

The media interface 1700 reads programs or data stored in a recording medium 1800, and supplies the read programs or data to the CPU 1100 via the RAM 1200. The CPU 1100 loads the programs from the recording medium 1800 into the RAM 1200 via the media interface 1700, and executes the loaded programs. The recording medium 1800 is constituted by an optical recording medium such as DVD (digital versatile disc) and PD (phase change rewritable disk), a magneto-optical recording medium such as an MO (magneto-optical disk), a tape medium, a magnetic recording medium, or a semiconductor memory, for example.

When the Computer 1000 functions as the generating device 100, for example, the CPU 1100 of the computer 1000 realizes the function of the control unit 130 by executing programs loaded into the RAM 1200. Respective sets of data within the storage unit 120 are stored in the HDD 1400. The CPU 1100 of the computer 1000 reads these programs from the recording medium 1800 and executes the programs. Alternatively, the CPU 1100 may acquire these programs from another device via the communication system 500.

### 6. Advantages

As described above, the generating device 100 according to the embodiment includes: the acquisition unit 131 that acquires network information concerning a company from information transmitted on a communication network; and a generation unit 132 that generates a model for predicting an index value (score) indicating credit to a company (hereinafter referred to as “first company”), based on a correlation between information acquired by the acquisition unit 131 and concerning a company (hereinafter referred to as “second company”) scored by the company data provider 50 corresponding to a third party, and a score of the second company given by the company data provider 50, by using information acquired by the acquisition unit 131 and concerning the first company not scored by the company data provider 50.

As described above, the generating device 100 according to this embodiment generates a model for calculating a score of a company based on user behaviors performed on the network, rather than financial information or the like of an enterprise generally used by a financial institution or the like. Accordingly, the generating device 100 accurately calculates credit to a small or middle-scale enterprise such as a start-up enterprise for which accumulation of financial information or the like is insufficient to such a level that evaluation of credit is difficult in a usual condition.

The generation unit 132 generates the model based on a correlation between scores of respective items constituting an overall score given by the company data provider 50, and sets of information concerning the company and associated with the respective items.

In this case, the generating device 100 classifies the credit to the company for each item to generate the model used for determination. Accordingly, the generating device 100 generates the model capable of calculating accurate credit without bias to a particular element.

The generation unit 132 generates the model through regression analysis of the scores of the respective items constituting the overall score given by the company data provider 50, and the quantized sets of information concerning the company and associated with the respective items.

In this case, the generating device 100 performs regression analysis to approximate the network information by the data provided by the company data provider 50. Accordingly, the generating device 100 is capable of generating a model, by using the network information, for calculating a score having a value equivalent to a value calculated by a company data specialist such as the company data provider 50.

The generation unit 132 changes types of the sets of information concerning the company and associated with the respective items constituting the overall score given by the company data provider 50, based on a result of the regression analysis.

In this case, the generating device 100 optimizes the information used for generation of the model by selecting appropriate network information used for generation of the model. Accordingly, the generating device 100 generates the model capable of calculating highly accurate credit.

The generation unit 132 generates the model by associating at least one of the respective items constituting the overall score given by the company data provider 50 with the corresponding information concerning the company, the respective items including stability, manager ability, growth potential, and openness to the public of the company.

In this case, the generating device 100 generates the model by using the network information corresponding to the classified evaluation item concerning the company. Accordingly, the generating device 100 generates the model capable of calculating highly accurate credit.

The acquisition unit 131 acquires information indicating at least any one of the number of searches corresponding to search queries concerning the company, search ranking, and a fluctuation rate of the number of searches for each of predetermined periods as information based on user behaviors performed on the Internet. The generation unit 132 generates the model by associating quantified information about at least any one of the number of searches, the search ranking, and the fluctuation rate of the number of searches for each of the predetermined periods acquired by the acquisition unit 131 with the score of the item.

In this case, the generating device 100 determines the degree of attention from ordinary users to the company corresponding to the evaluation target by analyzing the search information. Accordingly, the generating device 100 generates a highly accurate model based on the business continuation, growth potential or the like of the company as one determination element.

The acquisition unit 131 acquires at least any one of the number of views, the number of viewers, and a conversion rate of a website provided by the company as information based on user behaviors performed on the Internet. The generation unit 132 generates the model by associating quantified information about at least one of the number of views, the number of viewers, and the conversion rate acquired by the acquisition unit 131 with the score of the item.

In this case, the generating device 100 determines interests in the company corresponding to the evaluation target from ordinary users by analyzing information about the website provided by the company. Accordingly, the generating device 100 generates a highly accurate model based on the business continuation, growth potential or the like of the company as one determination element.

The acquisition unit 131 acquires at least any one of evaluation values from users of a product supplied by the company, the number of users of the product, and the number of posted reviews of the product as information based on user behaviors performed on the Internet. The generation unit 132 generates the model by associating quantified information about at least one of the evaluation values from the users of the product supplied by the company, the number of users of the product, and the number of posted reviews of the product acquired by the acquisition unit 131 with the score of the item.

In this case, the generating device 100 acquires information about evaluations of the company (or supplied product) from ordinary users by analyzing information about the product supplied by the company. Accordingly, the generating device 100 determines business continuation and growth potential of the company. In addition, evaluations from ordinary users are immediately reflected in a site concerning evaluations of a product, wherefore the generating device 100 is capable of directly recognizing reactions from ordinary users to the company. Accordingly, the generating device 100 generates a model capable of calculating a score further reflecting evaluations of users.

When a product supplied by the company is a program product, the acquisition unit 131 acquires at least any one of the number of downloads of the product, the number of users, an average use time of the product per user, and an operation rate of the product in a predetermined period. The generation unit 132 generates the model by associating quantified information about at least any one of the number of downloads of the product, the number of users, the average use time of the product per user, and the operation rate of the product in the predetermined period as information acquired by the acquisition unit 131 with the score of the item when the product supplied by the company is a program product such as an application.

Accordingly, the generating device 100 is capable of determining business continuation and growth potential of the company. More specifically, the generating device 100 generates the model which adds real-time reactions of users given from an application store or the like to determination elements.

The acquisition unit 131 acquires at least any one of the number of customers of the company, a continuous use rate by customers, and an average sale per customer as information based on user behaviors performed on the Internet. The generation unit 132 generates the model by associating quantified information about at least any one of the number of customers of the company, the continuous use rate by customers, and the average sale per customer acquired by the acquisition unit 131 with the index value of the item.

In this case, the generating device 100 determines management situations of the company by analyzing information about customers of the company. Accordingly, the generating device 100 is capable of determining a probability of bankruptcy, business continuation and the like, and generating a model for calculating more accurate score.

The generation unit 132 generates the model by using information concerning the second company belonging to an identical industry of the first company. In this case, the generating device 100 is capable of generating the model containing similarities such as numerals used in the industry, and calculating highly accurate credit to the company.

Several embodiments according to the present application described in detail with reference to the drawing are presented by way of example only. The present invention may be practiced in other modes containing various modifications and improvements made based on knowledge of those skilled in the art, such as the mode described in the section of disclosure of the invention.

The generating device 100 described above may be realized by a plurality of server computers, or external platforms or the like called via API (application programming interface) or network computing, for example, depending on the functions of the generating device 100. Accordingly, the configuration of the generating device 100 may be flexibly modified.

Expressions “unit (or section, module)” included in the appended claims may be replaced with “means” or “circuit”. For example, a generation unit may be replaced with a generating means or a generating circuit.

According to an advantage offered by an embodiment, accurate calculation of credit to a company is achievable.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A generating device comprising:
an acquisition unit that acquires information concerning a company from information transmitted on a communication network; and
a generation unit that generates a model for predicting an index value indicating credit to a first company based on information concerning the first company acquired by the acquisition unit, based on a correlation between information concerning a second company acquired by the acquisition unit and an index value indicating credit to the second company given by a third party.

2. The generating device according to claim 1, wherein the generation unit generates the model based on a correlation between index values of respective items constituting the index value given by the third party, and sets of information concerning the second company and associated with the respective items.

3. The generating device according to claim 2, wherein the generation unit generates the model through regression analysis of the index values of the respective items constituting the index value given by the third party, and the quantized sets of information concerning the second company and associated with the respective items.

4. The generating device according to claim 3, wherein the generation unit changes types of the sets of information concerning the second company and associated with the respective items constituting the index value given by the third party, based on a result of the regression analysis.

5. The generating device according to claim 2, wherein the generation unit generates the model by associating at least one of the respective items constituting the index value given by the third party with the corresponding information concerning the second company, the respective items including stability, manager ability, growth potential, and openness to the public of the second company.

6. The generating device according to claim 5, wherein
the acquisition unit acquires information indicating at least any one of the number of searches corresponding to search queries concerning the second company, search ranking, and a fluctuation rate of the number of searches for each of predetermined periods as information available on the communication network, and
the generation unit generates the model by associating quantified information about at least any one of the number of searches, the search ranking, and the fluctuation rate of the number of searches for each of the predetermined periods acquired by the acquisition unit with the index value of the item.

7. The generating device according to claim 5, wherein
the acquisition unit acquires at least any one of the number of views, the number of viewers, and a conversion rate of a website provided by the second company as information available on the communication network, and
the generation unit generates the model by associating quantified information about at least one of the number of views, the number of viewers, and the conversion rate acquired by the acquisition unit with the index value of the item.

8. The generating device according to claim 5, wherein
the acquisition unit acquires at least any one of evaluation values from users of a product supplied by the second company, the number of users of the product, and the number of posted reviews of the product as information available on the communication network, and
the generation unit generates the model by associating quantified information about at least one of the evaluation values from the users of the product supplied by the second company, the number of users of the product, and the number of posted reviews of the product acquired by the acquisition unit with the index value of the item.

9. The generating device according to claim 5, wherein
when a product supplied by the second company is a program product, the acquisition unit acquires at least any one of the number of downloads of the product, the number of users, an average use time of the product per user, and an operation rate of the product in a predetermined period, and
the generation unit generates the model by associating quantified information about at least any one of the number of downloads of the product, the number of users, the average use time of the product per user, and the operation rate of the product in the predetermined period with the index value of the item.

10. The generating device according to claim 5, wherein
the acquisition unit acquires at least any one of the number of customers of the second company, a continuous use rate by customers, and an average sale per customer as information available on the communication network, and
the generation unit generates the model by associating quantified information about at least any one of the number of customers of the second company, the continuous use rate by customers, and the average sale per customer acquired by the acquisition unit with the index value of the item.

11. The generating device according to claim 1, wherein the generation unit generates the model by using information concerning the second company belonging to an identical industry of the first company.

12. A generating method executed by a computer, the method comprising:
an acquiring step for acquiring information concerning a company from information transmitted on a communication network; and
a generating step for generating a model for predicting an index value indicating credit to a first company based on information concerning the first company acquired by the acquisition unit, based on a correlation between information concerning a second company acquired by the acquiring step and an index value indicating credit to the second company given by a third party.

13. A non-transitory computer readable storage medium having stored therein a generating program, the generating program causes a computer to execute:
an acquiring procedure for acquiring information concerning a company from information transmitted on a communication network; and
a generating procedure for generating a model for predicting an index value indicating credit to a first company based on information concerning the first company acquired by the acquisition unit, based on a correlation between information concerning a second company acquired by the acquiring procedure and an index value indicating credit to the second company given by a third party.
